(19) United States
(12) Patent Application Publication
(10) Pub. No.: US 2008/0154988 A1
(43) Pub. Date: Jun. 26, 2008

(54) HSM CONTROL PROGRAM AND METHOD

(75) Inventors: Kensuke Shiozawa, Kawasaki (JP); Yoshitake Shinkai, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/950,828

(22) Filed: Dec. 5, 2007

Related U.S. Application Data
(63) Continuation of application No. PCT/JP2005/010650, filed on Jun. 10, 2005.

(51) Int. Cl. G06F 12/00

(52) U.S. Cl. 707/204

(57) ABSTRACT

An HSM control program allows a computer to execute: a metadata management step that manages primary storage location information which is location information of file data of the file on the primary storage unit, secondary storage location information which is location information of the file data on the secondary storage unit, and a file status value indicating the status of the file, as well as performs control operation on a file; an HSM information management step that manages HSM information including a replication of the secondary storage location information and policy information; and a data migration step that migrates the file data between the primary and secondary storage units based on the file control performed by the metadata management step and HSM information managed by the HSM information management step.

### TECHNICAL FIELD

The present invention relates to an HSM control program, an HSM control apparatus, and an HSM control method that manage a hierarchical storage apparatus.

### BACKGROUND ART

In a recent information society where tremendous amount of electronic data are produced, increase in data management cost has been seen as a problem. For example, in a conventional simple tape backup system, stored data only increases incrementally. In order to separate necessary data for storage from unnecessary data to thereby reduce the amount of data to be stored, an intelligent data management system is demanded in which the minimum amount of data is stored. Further, long term storage of specific data is required by law. In such circumstances, the importance of intelligent data management system is advocated more today than ever before.

As one effective countermeasure effective against such a problem, there is available an HSM (Hierarchical Storage Management). The HSM is a technique that migrates data in units of a file in a hierarchical storage apparatus in which a plurality storage units are constructed in a hierarchical structure based on a statically or dynamically defined policy (e.g., storage period or store interval). A typical hierarchical storage apparatus includes an expensive, high-speed, and low capacity RAID (Redundant Array of Inexpensive Disks) as a primary storage unit and an inexpensive, low-speed, and large capacity tape library as a secondary storage unit.

As a prior art relating to the present invention, the following Patent Document 1 is known. This method for forming back-up copy discriminates volume ID in the middle of intermediate copying step to prevent a storage subsystem from bringing out a source or, temporary copy having trouble-causing indiscriminable volume IDs, thus being more fault-tolerant.
Patent Document 1: Jpn. Pat. Appln. Laid-Open Publication No. 2002-215334

### DISCLOSURE OF THE INVENTION

### Problems to be Solved by the Invention

Here, two examples of conventional HSM apparatuses will be described.

FIG. 8 is a view showing an example of a configuration of a first conventional HSM apparatus. The first HSM apparatus of FIG. 8 includes an FS (File System) 101, a support agent 102, a primary storage unit 103, and a secondary storage unit 104. In the first HSM apparatus, the support agent 102 provided outside the FS 101 is in charge of managing all metadata concerning the HSM.

However, since file data location information on the primary storage unit 103 and file data location information on the secondary storage unit 104 are controlled in a fully distributed manner, there is a higher risk that consistency between the primary and secondary storage units may be lost. For example, occurrence of inconsistency such as one regarding an unreleased file as a released file or regarding a file that has not been recalled as a recalled file may result in file data corruption.

Further, the FS 101 must perform inquiry to the support agent 102 every time a user accesses to a released file in order to determine the need of recall, thus deteriorating performance. Furthermore, in the case where update of a file that has been archived occurs, the FS 101 must cooperate with the support agent 102 in order to determine whether to invalidate or reflect the update, thereby deteriorating performance.

FIG. 9 is a view showing an example of a second conventional HSM apparatus. In FIG. 9, the same reference numerals as those in FIG. 8 denote the same or corresponding parts as those in FIG. 8, and the descriptions thereof will be omitted here. As compared to the first HSM apparatus, the second HSM apparatus includes an FS 201 in place of the FS 101 and does not require the support agent 102. In the second HSM apparatus, all metadata concerning the HSM are managed by the FS 201. The metadata includes so-called policy control information indispensable for realizing the HSM, such as archive storage period, information for specifying data to be archived, and archive time interval.

The function of the policy control needs to be easily enhanced depending on the operation method of the HSM. However, in a system like the second HSM apparatus in which the policy control information is managed by the FS 201, a large-scale and difficult-to-maintain modification of a file system is required for realization of the function enhancement.

The second HSM apparatus is one obtained by adding the HSM function to a local file system which can be used only within a single node and, now, there is a demand that a cluster file system for enhancing the performance of a large-scale file system have the HSM function.

The present invention has been made to solve the above problems, and an object thereof is to provide an HSM control program, an HSM control apparatus, and an HSM control method which are capable of enhancing reliability, expandability and performance and accepting a cluster file system.

### Means for Solving the Problems

To solve the above problems, according to a first aspect of the present invention, there is provided an HSM control program allowing a computer to execute an HSM control method for managing a file system using primary and secondary storage units, the program allowing the computer to execute: a metadata management step that manages, as metadata of a file, primary storage location information which is location information of file data of the file on the primary storage unit, secondary storage location information which is location information of the file data on the secondary storage unit, and a file status value indicating the status of the file, as well as performs control operation on a file; an HSM information management step that manages HSM information including a replication of the secondary storage location information and policy information based on the file control performed by the metadata management step; and a data migration step that migrates the file data between the primary and secondary storage units based on the file control performed by the metadata management step and HSM information managed by the HSM information management step.

In the HSM control program according to the present invention, the data migration step stores the file data of a file and path information of the file in the secondary storage unit.

In the HSM control program according to the present invention, the file system is a cluster file system, and the metadata management step controls the cluster file system.

In the HSM control program according to the present invention, the metadata management step controls archive processing that copies the file data from the primary storage unit to secondary storage unit, release processing that releases the file data on the primary storage unit, recall processing that copies the file data from the secondary storage unit to primary storage unit, and invalidation processing that invalidates the file data on the secondary storage unit.

In the HSM control program according to the present invention, the metadata management step gives the file, as the file status value, any of the following statuses including: an archive invalidate status where the latest file data exists only in the primary storage unit, an archiving status where the archive processing is being performed, an archived status where the latest file data exists both in the primary and secondary storage units, a releasing status where the release processing is being performed, a released status where the latest file data exists only in the secondary storage unit, an allocating status where the area in the primary storage unit used for the recall processing is being secured, and a recalling status where the recall processing is being performed.

In the HSM control program according to the present invention, the HSM information management step selects an archive processing target file based on the HSM information.

In the HSM control program according to the present invention, the metadata management step performs collection of tokens from all nodes in the archive processing and release processing.

In the HSM control program according to the present invention, the HSM information management step stores a file of several generations in the secondary storage unit through the archive processing and invalidation processing to retain the secondary storage location information of the file so as to manage the file of several generations.

According to a second aspect of the present invention, there is provided an HSM control apparatus that manages a file system using primary and secondary storage units, comprising: a metadata management section that manages, as metadata of a file, primary storage location information which is location information of file data of the file on the primary storage unit, secondary storage location information which is location information of the file data on the secondary storage unit, and a file status value indicating the status of the file, as well as performs control operation on a file; an HSM information management section that manages HSM information including a replication of the secondary storage location information and policy information based on the file control performed by the metadata management section; and a data migration section that migrates the file data between the primary and secondary storage units based on the file control performed by the metadata management section and HSM information managed by the HSM information management section.

In the HSM control apparatus according to the present invention, the data migration section stores the file data of a file and path information of the file in the secondary storage unit.

In the HSM control apparatus according to the present invention, the file system is a cluster file system, and the metadata management section controls the cluster file system.

In the HSM control apparatus according to the present invention, the metadata management section controls archive processing that copies the file data from the primary storage unit to secondary storage unit, release processing that releases the file data on the primary storage unit, recall processing that copies the file data from the secondary storage unit to primary storage unit, and invalidation processing that invalidates the file data on the secondary storage unit.

In the HSM control apparatus according to the present invention, the metadata management section gives the file, as the file status value, any of the following statuses including: an archive invalidate status where the latest file data exists only in the primary storage unit, an archiving status where the archive processing is being performed, an archived status where the latest file data exists both in the primary and secondary storage units, a releasing status where the release processing is being performed, a released status where the latest file data exists only in the secondary storage unit, an allocating status where the area in the primary storage unit used for the recall processing is being secured, and a recalling status where the recall processing is being performed.

In the HSM control apparatus according to the present invention, the HSM information management section selects an archive processing target file based on the HSM information.

In the HSM control apparatus according to the present invention, the metadata management section performs collection of tokens from all nodes in the archive processing and release processing.

In the HSM control apparatus according to the present invention, the HSM information management section stores a file of several generations in the secondary storage unit through the archive processing and invalidation processing to retain the secondary storage location information of the file so as to manage the file of several generations.

According to a third aspect of the present invention, there is provided an HSM control method that manages a file system using primary and secondary storage units, comprising: a metadata management step that manages, as metadata of a file, primary storage location information which is location information of file data of the file on the primary storage unit, secondary storage location information which is location information of the file data on the secondary storage unit, and a file status value indicating the status of the file, as well as performs control operation on a file; an HSM information management step that manages HSM information including a replication of the secondary storage location information and policy information based on the file control performed by the metadata management step; and a data migration step that migrates the file data between the primary and secondary storage units based on the file control performed by the metadata management step and HSM information managed by the HSM information management step.

### BRIEF DESCRIPTION OF THE DRAWINGS

FIG. 1 is a block diagram showing an example of a configuration of an HSM apparatus according to the present invention;

FIG. 2 is a status transition diagram showing an example of a file status value according to the present invention;

FIG. 3 is a view showing an example of file data location management according to the present invention;

FIG. 4 is a sequence diagram showing an example of operation of archive processing according to the present invention;

FIG. 5 is a sequence diagram showing an example of operation of release processing according to the present invention;

FIG. 6 is a sequence diagram showing an example of operation of recall processing according to the present invention;

FIG. 7 is a sequence diagram showing an example of operation of invalidation processing according to the present invention;

FIG. 8 is a view showing an example of a configuration of a first conventional HSM apparatus; and

FIG. 9 is a view showing an example of a second conventional HSM apparatus.

### BEST MODE FOR CARRYING OUT THE INVENTION

An embodiment of the present invention will be described below with reference to the accompanying drawings.

An HSM control apparatus according to the present invention handles HSM metadata. The HSM metadata corresponding to a file status value and an archive identifier are included in mode of a file system and are managed by a metadata server. The remaining HSM metadata such as policy information is managed by an HSM agent. Further, the HSM control apparatus according to the present invention allows the metadata server to execute the basic functions of the HSM. Further, the HSM control apparatus according to the present invention allows an HSM agent to manage an HSM database which is a replication of the location information of an archive. Furthermore, the HSM control apparatus according to the present invention uses this HSM database to perform generation management.

In the present embodiment, an HSM control apparatus using a cluster file system will be described.

A description will first be given of a configuration of the HSM control apparatus according to the present invention.

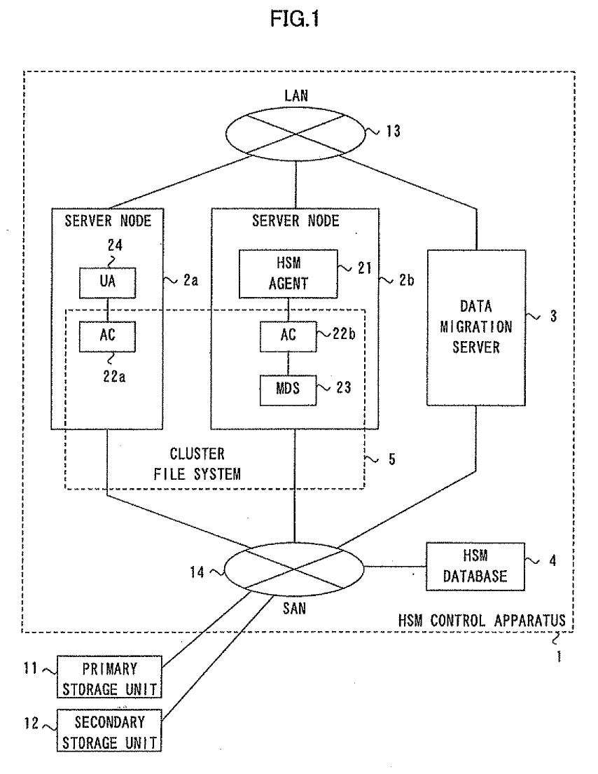

FIG. 1 is a block diagram showing an example of a configuration of an HSM apparatus according to the present invention. The HSM apparatus of FIG. 1 includes an HSM control apparatus 1 and primary and secondary storage units 11 and 12 which are connected to the HSM control apparatus 1. The HSM control apparatus 1 includes a server node 2a, a server node 2b, a data migration server 3, an HSM database 4, a LAN (Local Area Network) 13, and a SAN (Storage Area Network) 14. The server node 2a, server node 2b, and data migration server 3 are connected to each other through the LAN 13. The server node 2a, server node 2b, data migration server 3, HSM database 4, primary storage unit 11, and secondary storage unit 12 are connected to each other through the SAN 14.

The server node 2a includes an AC (Access Client) 22a and a user application (UA) 24. The server node 2b includes an HSM agent 21, an AC 22b, and an MDS (Metadata Server) 23. The AC 22a, AC 22b, and MDS 23 constitute a cluster file system 5.

The AC 22a and AC 22b, each serve as a user I/O, receive a request from the user application 24 or HSM agent 21 and pass the received request to the MDS 23. The MDS 23 collectively manages cache consistency and namespace between cluster nodes and, more specifically, manages metadata including inode, as well as give a predetermined instruction to the AC 22a, AC 22b, or data migration server 3. Further, the MDS 23 performs token control so as to realize exclusion of data in the cluster file system 5. The HSM agent 21 extracts namespace information as needed to build and manage the HSM database 4 including HSM metadata and location information on the secondary storage unit 12 based on policy information including archive interval or information concerning the secondary storage unit which is a data save destination. Further, the HSM agent 21 issues an archive request or release request to the AC 22b according to a request from an administrator, as well as serves as an intermediary between the AC 22b and data migration server 3. The user application 24 issues a data reference request, a data update request, and a size change request to the AC 22a.

The primary storage unit 11 has a metadata area and a user area. The metadata area is an area for storing inode for each file which is file system metadata and user area is an area for storing file data corresponding to the metadata. The secondary storage unit 12 stores file data copied as an archive from the primary storage unit 11 and path information of the file data. The HSM database 4 stores archive meta concerning the secondary storage unit 12.

The inode for each file managed by the MDS 23 and stored in the metadata area of the primary storage unit 11 includes extent information, file status value, and archive identifier. The extent information indicates the location of file data on the primary storage unit 11. The archive identifier indicates the location of file data on the secondary storage unit 12.

A description is given here of the file status value.

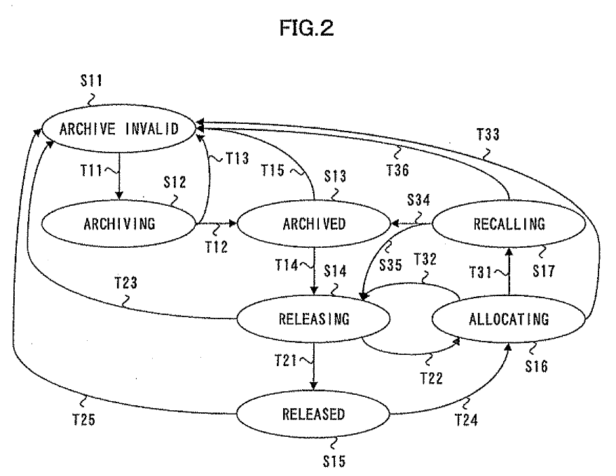

FIG. 2 is a status transition diagram showing an example of the file status value according to the present invention. As the file status value, there exist 7 statuses: archive invalid status S11, archiving status S12, archived status S13, releasing status S14, released status S15, allocating status S16, and recalling status S17.

The archive invalid status S11 represents a steady status where the latest version of file data exists only on the primary storage unit 11. The archive invalid status S11 also represents the initial status value at the time point when a new file is created. When an archive request is generated in the archive invalid status S11, the file status transits to the archiving status S12 before target file data is copied to the secondary storage unit 12 (T11).

The archiving status S12 represents a transient status where the target file data is being copied from the primary storage unit 11 to secondary storage unit 12 by archive processing on the basis of the archive request. After completion of the copy in the archiving status S12, the file status transits to the archived status S13 (T12). When an update or deletion of a copy source file occurs during the copy in the archiving status S12, the copy is canceled and file status transits to the archive invalid status S11 (T13).

The archived status S13 represents a steady status where the latest version of file data exists both on the primary and secondary storage units 11 and 12. When a release request is generated in the archived status S13, the file status transits to the releasing status S14 (T14). When an update of the file data is generated in the archived status S13, the file status transits to the archive invalid status S11 (T15).

The releasing status S14 represents a transient status where the extent information of target file is being discarded by release processing on the basis of the release request. After completion of the discard of the extent information in the releasing status S14, the file status transits to the released status S15 (T21). When an access to the file data is generated in the releasing status S14, the file status transits to the allocating status S16 which is a preparation status of recall (T22). However, this occurs only in cases where a system crash is generated during the discard of the extent information. In general, an access to target file data is inhibited during the discard of the extent information. When processing that deletes target file or sets data size to 0 is generated in the releasing status S14, the file status transits to the archive invalid status S11 (T23). However, this also occurs only in cases where a system crash is generated during the discard of the extent information.

The released status S15 represents a steady status where the latest version of file data exists only on the secondary storage unit 12. When an access to file data is generated in the released status S15, the file status transmits to the allocating status S16 which is a preparation status of recall (T24). When processing that deletes target file or sets data size to 0 is generated in the released status S15, the file status transits to the archive invalid status S11 (T25).

The allocating status S16 represents a transient status where an allocation of the extent information for recall is being performed by recall processing on the basis of a recall request. After completion of the allocation of the extent information in the allocating status S16, the file status transits to the recalling status S17 (T31). When a release request is generated in the allocating status S16, the file status transits to the releasing status S14 (T32). However, this occurs only in cases where a system crash is generated during the allocation of the extent information. In general, an access to target file data is inhibited during the allocation of the extent information. When processing that deletes target file or sets data size to 0 is generated in the allocating status S16, the file status transits to the archive invalid status S11 (T33). However, this also occurs only in cases where a system crash is generated during the allocation of the extent information.

The recalling status S17 represents a transient status where copy for recall is being performed by recall processing on the basis of a recall request. After completion of the copy in the recalling status S17, the file status transits to the archived status S13 (T34). When a release request is generated in the recalling status S17, the file status transits to the releasing status S14 (T35). However, this occurs only in cases where a system crash is generated during the copy. In general, an access to target file data is inhibited during the copy. When processing that deletes target file or sets data size to 0 is generated in the recalling status S17, the file status transits to the archive invalid status S11 (T36). However, this also occurs only in cases where a system crash is generated during the copy.

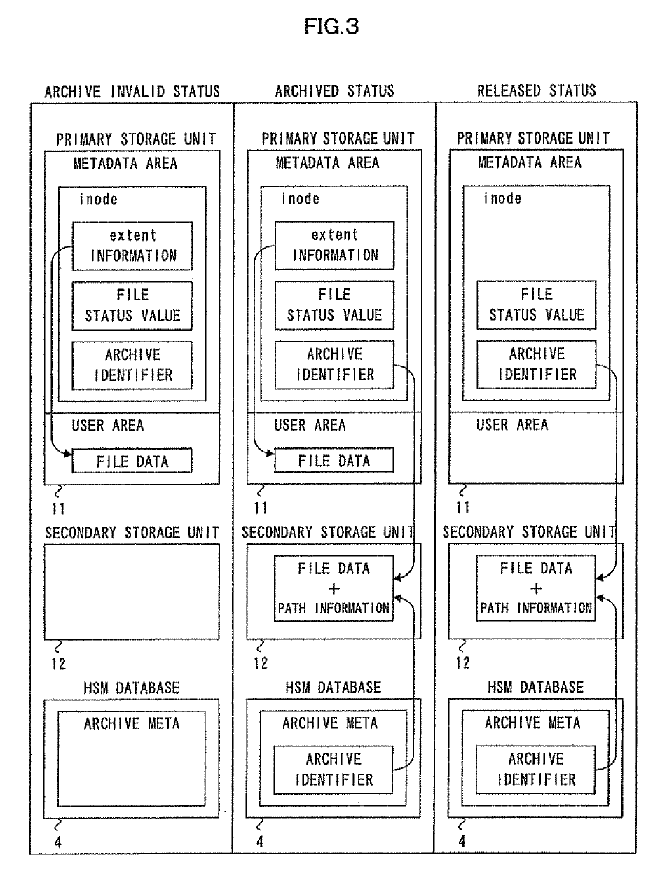

A description will next be given of location management of file data performed using the archive identifier. FIG. 3 is a view showing an example of file data location management according to the present invention. This figure shows the location information of target files stored in the primary storage unit 11, secondary storage unit 12, and HSM database 4 or data of the target files that the location information indicate. In the metadata area of the primary storage unit 11, inode for each file is stored. The inode for each target file includes, as needed, extent information, file status value, and archive identifier. The extent information indicates the location of the file data of a target file in the user area of the primary storage unit 11, and the archive identifier indicates the location of the file data and path information of a target file in the secondary storage unit 12. Further, the secondary storage unit 12 stores the file data and path information of an archived target file. Further, an archive identifier for each file is stored in the archive meta of the HSM database 4. Like the inode, the archive identifier indicates the location of the file data and path information of a target file in the secondary storage unit 12.

Further, FIG. 3 shows, with respect to three steady statuses of the archive invalid status S11, archived status S13, and released status S15, a relationship between each location information of a given target data and data that the location information indicates.

In the archive invalid status S11, the extent information in inode indicates the location of the file data of a target file in the user area of the primary storage unit 11. In the secondary storage unit 12, data concerning the target file does not exist. In the archive meta, the archive identifier of the target file does not exist.

In the archived status S13, the extent information in inode indicates the location of the file data of the target file in the user area of the primary storage unit 11. The archive identifier in inode indicates the location of the file data and path information of the target file in the secondary storage unit 12. The archive identifier in the archive meta also indicates the same content as the archive identifier in inode indicates, i.e., the location of the file data and path information of the target file in the secondary storage unit 12.

In the released status S15, the extent information in inode has been discarded and does not exist. The archive identifier in inode indicates the location of the file data and path information of the target file in the secondary storage unit 12. The archive identifier in the archive meta also indicates the same content as the archive identifier in inode indicates, i.e., the location of the file data and path information of the target file in the secondary storage unit 12.

A description will next be given of details of the respective operations of the archive processing, release processing, recall processing, and invalidation processing which are basic functions of the HSM control apparatus according to the present invention.

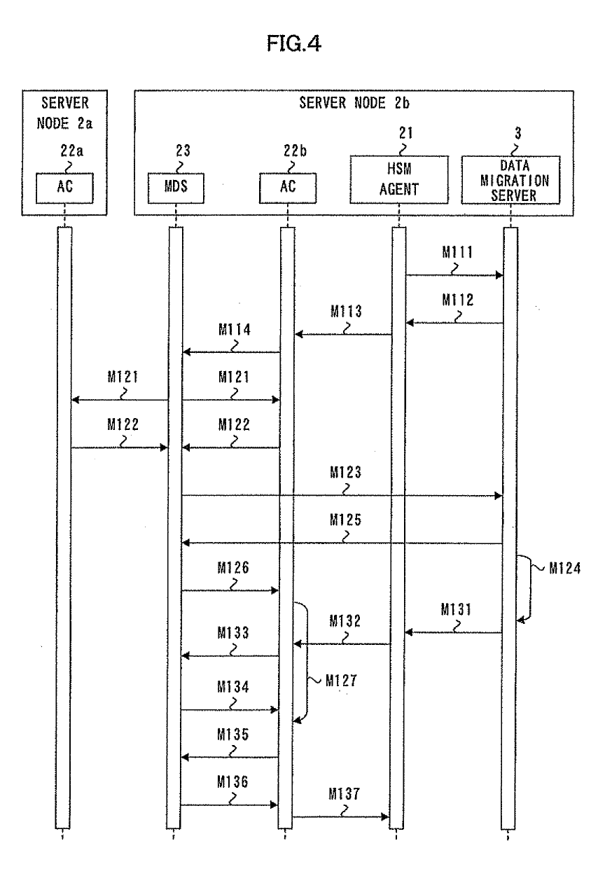

First, the archive processing will be described. FIG. 4 is a sequence diagram showing an example of operation of the archive processing according to the present invention. When an administrator issues an archive request to the server node 2b, this sequence is started.

Then, the HSM agent 21 selects an archive target file based on the policy information of the HSM database 4 or namespace information copied from the primary storage unit 11 and makes a reservation of an archive identifier to the data migration server 3 (M111). The data migration server 3 returns the number of the reserved archive identifier to the HSM agent 21 (M112). Then, the HSM agent 21 issues an archive request of the archive target file to the MDS 23 (M114) through the AC 22b (M113). Added to this archive request are inode number/generation number of the archive target file, previously reserved archive identifier, and path name of the archive target file to be included in the archive data.

Subsequently, on condition that the archive target file is in the archive invalid status S11 where the archive target file can be archived and is required to be archived, the MDS 23 collects all tokens from the AC 22a and AC 22b (M121, M122) and purges the cache of the data of the archive target file. Then, the MDS 23 records a received archive identifier in inode and, at the same time, causes the file status value of inode to transit from the archive invalid status S11 to archiving status S12. The MDS 23 then issues a request of activation of copy processing for the archive target file to the data migration server 3 (M123). This request includes the extent information and archive identifier of the archive target file.

Subsequently, the data migration server 3 copies the file data of the archive target file specified by the received extent information from the primary storage unit 11 to a given location on the secondary storage unit 12 specified by the received archive identifier, as well as starts asynchronous copy processing of adding path information, file attribute, and file size of the archive target file (M124) and replies to the MDS 23 (M125).

Then, as a reply to M114, the MDS 23 sends a special error reply to request the AC 22b to wait for completion of the copy processing (M126). Upon receiving the error reply, the AC 22b waits for reception of a wake-up request to be described later (M127).

After completion of the copy processing of M124, the data migration server 3 25 issues a copy completion notification to the MDS 23 through the HSM agent 21 and AC 22b (M131, M132, M133). Subsequently, the MDS 23 causes the file status value of the archive target file to transit to the archived status S13 and issues a wake-up request to the AC 22b in a waiting status (M134). Upon receiving the wake-up request, the AC 22b reissues, to the MDS 23, the same archive request as that in M114 for confirmation of the file status value or archive identifier of the archive target file (M135). Then, the MDS 23 detects that the file status value of the archive target file is the archived status S13, sends a normal reply to the HSM agent 21 which is an issuance source of the archive request (M137) through the AC 22b (M136), and ends this sequence.

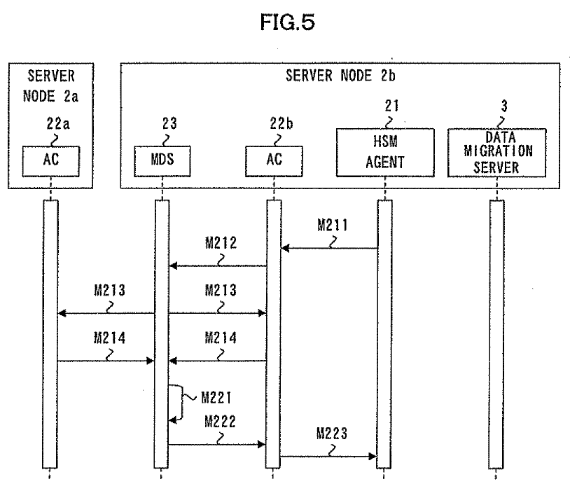

Next, the release processing will be described. FIG. 5 is a sequence diagram showing an example of operation of the release processing according to the present invention. When an administrator issues a release request to the server node 2b, this sequence is started.

The HSM agent 21 issues a release request to the MDS 23(M212) through the AC 22b (M211). Then, on condition that a release target file is in the archived status S13 where the release target file can be released, the MDS 23 collects all tokens from the AC 22a and AC 22b (M213, M214) and purges the cache of the data of the release target file. Then, the MDS 23 causes the file status value of the release target file to transit to the releasing status S14 and discards all the extent information in the release target file (M221). After completion of the discard of all the extent information in the release target file, the MDS 23 causes the file status value of the release target file to transit to the released status S15, sends a normal reply to the HSM agent 21 which is an issuance source of the release request (M223) through the AC 22b (M222), and end this sequence.

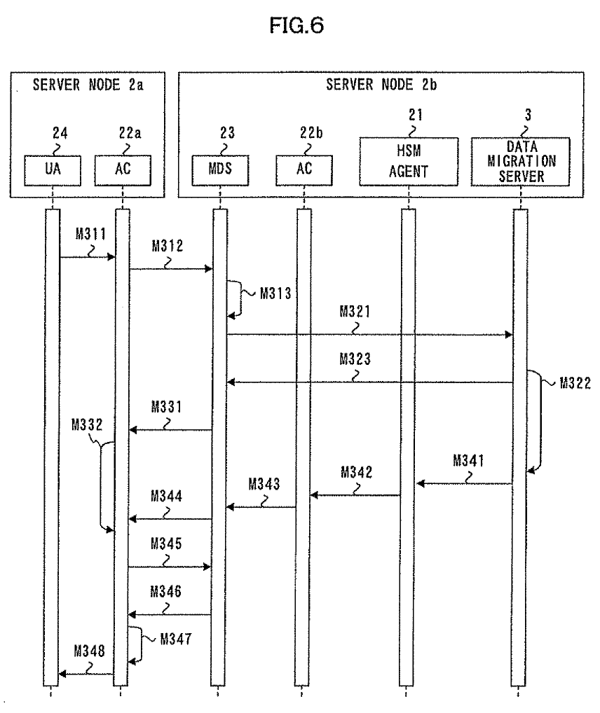

Next, the recall processing will be described. FIG. 6 is a sequence diagram showing an example of operation of the recall processing according to the present invention. When the user application 24 of the server node 2a makes a data access request for data reference or data update or a size change request with respect to the released file, this sequence is started. Here, a case where the user application 24 makes a data reference request of the released file as a trigger to start the recall processing will be described.

The user application 24 passes the data reference request of the released file to the AC 22a (M311). Then, when the request from the user application 24 is a data access request such as data reference, the AC 22a requests the MDS 23 to transmit thereto a token for guaranteeing cache consistency in the access target area (M312). Since the MDS 23 collects a token of the released file at the time point when the release processing of this file is performed, and, further, since a securement of the token of the release target file serves as a trigger to start the recall processing, it is impossible for the AC 22a to possess the token at the time point of generation of an access request for the released file. In the case where the request from the user application 24 is a size change request, the AC 22a passes this request directly to the MDS 23.

Subsequently, the MDS 23 causes the file status value of a recall target file which is the abovementioned released file to transit to the allocating status S16 and performs an allocation of extent information in the recall destination (M313). After completion of the allocation, the MDS 23 causes the file status value of the recall target file to the recalling status S17 and issues a request of activation of copy processing for the recall target file to the data migration server 3 (M321). The archive identifier that has been recorded in inode at the archive time is added to this request to allow the data migration server 3 to identify archive data of the recall target file. Then, the data migration server 3 starts copy processing for recall (M322) and, at the same time, returns a reply to the MDS 23 (M323).

Then, as a reply to M312, the MDS 23 sends a special error reply to request the AC 22a to wait for completion of the copy processing (M331). Upon receiving the error reply, the AC 22a waits for reception of a wake-up request to be described later (M322).

After completion of the copy processing of M322, the data migration server 3 issues a copy completion notification to the MDS 23 (M343) through the HSM agent 21 (M341) and AC 22b (M342). Subsequently, the MDS 23 causes the file status value of the recall target file to transit to the archived status S13 and issues a wake-up request to the AC 22a in a waiting status (M344). Upon receiving the wake-up request, the AC 22a reissues, to the MDS 23, the same data access request or size change request as that in M312 for confirmation of the file status value or archive identifier of the recall target file (M345). Then, the MDS 23 detects that the file status value of the recall target file is the archived status S13 where recall of a file is unnecessary, performs processing corresponding to the request in M312, and passes a reply to the AC 22a(M346). Upon receiving the replay, the AC 22a performs processing such as data reference for the recalled file (M347), returns a reply to the user application 24 (M348), and ends this sequence.

In the case where the user application 24 makes a data update request of the released file as a trigger to start the recall processing, the AC 22a requests the MDS 23 to transmit thereto a token for data update in M312. In this case, invalidation processing to be described later is performed in M343 where the request is reissued after completion of the recall processing. The same applies to the case where the user application 24 makes a size change request of the released file as a trigger to start the recall processing.

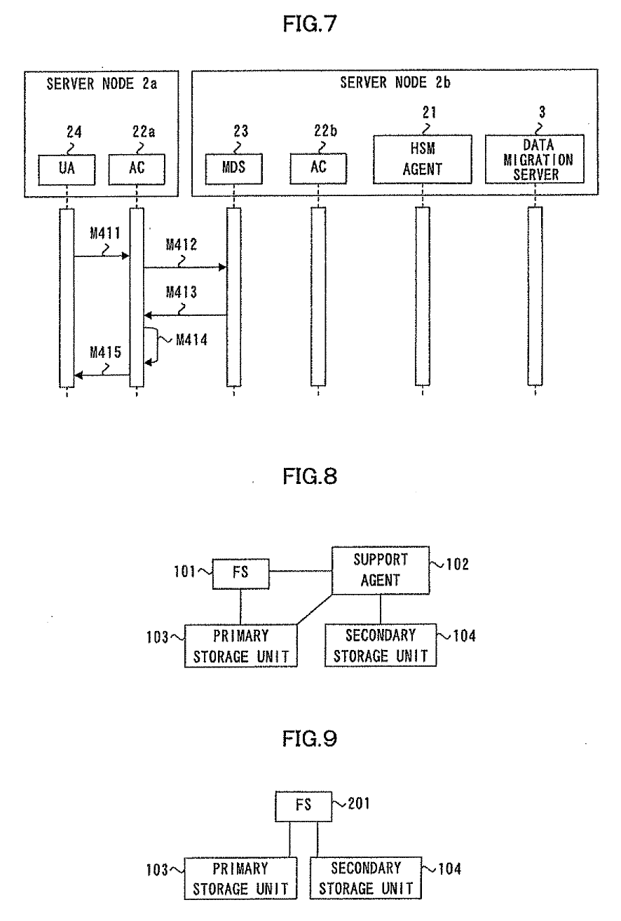

Next, the invalidation processing will be described. FIG. 7 is a sequence diagram showing an example of operation of the invalidation processing according to the present invention. When the user application 24 of the server node 2a makes any of the following requests including: a data update request, size change request, and deletion request with respect to a file in the archived status S13, this sequence is started. Here, a case where the user application 24 makes a data update request of a file in the archived status S13 as a trigger to start the invalidation processing will be described.

The user application 24 passes a data update request of a file in the archived status S13 to the AC 22a (M411). Then, the AC 22a passes the received request to the MDS 23 (M412). When a file targeted by the data update request is in the archived status S13, the MDS 23 causes the target file to transit to the archive invalidation status S11, as well as clears the corresponding archive identifier recorded in inode, processes the data update request, and issues a normal reply to the AC 22a (M413). Then, the AC 22a performs data update (M414), replies to the user application 24 (M415), and ends this sequence.

In the case where the file targeted by the data update request is in any of the following statuses including the releasing status S14, released status S15, allocating status S16, and recalling status S17 in M413, the MDS 23 preliminarily performs the recall processing in principle. However, only in the case where processing that deletes target file or sets data size to 0 is generated as a request, the invalidation processing is carried out without performing the preliminary recall processing.

According to the abovementioned basic functions, the MDS 23 having the authority to perform cache purge of a target file and update of metadata manages the location information of file data, as well as performs the archive processing, release processing, recall processing, and invalidation processing to thereby guarantee consistency between the primary and secondary storage units 11 and 12. As a result, it is possible not only to improve reliability but also enhance performance as compared to a method involving cooperation with an agent provided outside the file system. Further, metadata for HSM that is not closely related to the metadata of the file system is managed by the HSM agent 21 provided outside the file system, thereby facilitating function enhancement. Further, it is possible to realize an HSM apparatus accepting the abovementioned cluster file system.

Further, in the archive processing, the data migration server 3 copies file data from the primary storage unit 11 to secondary storage unit 12, as well as adds path information and the like to the file data. Thus, even if the file system crashes, the system can be recovered only with the secondary storage unit 12. Further, the file status value is managed in inode together with the archive identifier. Thus, even if the file system has broken down at any timing, it is possible to maintain consistency if appropriate processing is performed based on the file status value after system restart, thereby achieving a fault tolerant system.

A description will be given of generation file management which is an application function achieved using the abovementioned basic functions.

The HSM agent 21 forcibly performs the archive processing for a target file to acquire a base generation image. Even if the target file has not been updated after the previous archive processing, the HSM agent 21 forcibly performs the archive processing.

Thereafter, the HSM agent 21 determines whether or not to perform the archive processing for the target file based on predetermined policy information such as time interval information. In the case where the target file has not been updated after the previous archive processing, the HSM agent 21 does not perform the archive processing. On the other hand, in the case where an update request of the target file is generated after the previous archive processing, the recall processing and invalidation processing are performed according to the update request and followed by the archive processing to create new generation archive data.

After that, the HSM agent 21 retains the archive identifier before the invalidation processing of the target file for a predetermined time period so as to prepare for restoration of the generation file.

With the above simple procedure, the generation file management aiming to make backup can be realized. It goes without saying that this generation file management is applicable not only to a single file but also to a file aggregate within a given directory tree.

Although the HSM apparatus employs a cluster file system in the present embodiment, the present invention can be applied to a local file system.

Further, it is possible to provide a program that allows a computer constituting the HSM control apparatus to execute the above steps as an HSM control program. By storing the above program in a computer-readable storage medium, it is possible to allow the computer constituting the HSM control apparatus to execute the program. The computer-readable storage medium mentioned here includes: an internal storage device mounted in a computer, such as ROM or RAM; a portable storage medium such as a CD-ROM, a flexible disk, a DVD disk, a magneto-optical disk, or an IC card; a database that holds computer program; another computer and database thereof; and a transmission medium on a network line.

A metadata management step and metadata management section correspond to the MDS 23 in the present embodiment. An HSM information management step and HSM information management section correspond to the HSM agent in the present embodiment. A data migration step and data migration section correspond to the data migration server in the present embodiment. Primary storage location information corresponds to the extent information in the present embodiment. Secondary storage location information corresponds to the archive identifier in inode in the present embodiment. A replication of secondary storage location information corresponds to the archive identifier in archive meta in the present embodiment. A node corresponds to the server nodes 2a and 2b in the present embodiment.

### INDUSTRIAL APPLICABILITY

As described above, according to the present invention, a part of the HSM metadata including the location information and status value of file data are managed by the metadata server provided in the file system, and other HSM metadata are managed by the HSM agent provided outside the file system, thereby enhancing reliability and performance of the HSM apparatus. Further, according to the present invention, the HSM control apparatus accepting a cluster file system can be realized. Further, by executing basic functions of the HSM control apparatus according to the present invention, generation file management can easily be achieved.

1. An HSM control program allowing a computer to execute an HSM control method for managing a file system using primary and secondary storage units, the program allowing the computer to execute:
a metadata management step that manages, as metadata of a file, primary storage location information which is location information of file data of the file on the primary storage unit, secondary storage location information which is location information of the file data on the secondary storage unit, and a file status value indicating the status of the file, as well as performs control operation on a file;
an HSM information management step that manages HSM information including a replication of the secondary storage location information and policy information based on the file control performed by the metadata management step; and
a data migration step that migrates the file data between the primary and secondary storage units based on the file control performed by the metadata management step and HSM information managed by the HSM information management step.

2. The HSM control program according to claim 1, wherein
the data migration step stores the file data of a file and path information of the file in the secondary storage unit.

3. The HSM control program according to claim 1, wherein
the file system is a cluster file system, and
the metadata management step controls the cluster file system.

4. The HSM control program according to claim 1, wherein
the metadata management step controls archive processing that copies the file data from the primary storage unit to secondary storage unit, release processing that releases the file data on the primary storage unit, recall processing that copies the file data from the secondary storage unit to primary storage unit, and invalidation processing that invalidates the file data on the secondary storage unit.

5. The HSM control program according to claim 4, wherein
the metadata management step gives the file, as the file status value, any of the following statuses including: an archive invalidate status where the latest file data exists only in the primary storage unit, an archiving status where the archive processing is being performed, an archived status where the latest file data exists both in the primary and secondary storage units, a releasing status where the release processing is being performed, a released status where the latest file data exists only in the secondary storage unit, an allocating status where the area in the primary storage unit used for the recall processing is being secured, and a recalling status where the recall processing is being performed.

6. The HSM control program according to claim 1, wherein
the HSM information management step selects an archive processing target file based on the HSM information.

7. The HSM control program according to claim 4, wherein
the metadata management step performs collection of tokens from all nodes in the archive processing and release processing.

8. The HSM control program according to claim 1, wherein
the HSM information management step stores a file of several generations in the secondary storage unit through the archive processing and invalidation processing to retain the secondary storage location information of the file so as to manage the file of several generations.

9. An HSM control apparatus that manages a file system using primary and secondary storage units, comprising:
a metadata management section that manages, as metadata of a file, primary storage location information which is location information of file data of the file on the primary storage unit, secondary storage location information which is location information of the file data on the secondary storage unit, and a file status value indicating the status of the file, as well as performs control operation on a file;
an HSM information management section that manages HSM information including a replication of the secondary storage location information and policy information based on the file control performed by the metadata management section; and
a data migration section that migrates the file data between the primary and secondary storage units based on the file control performed by the metadata management section and HSM information managed by the HSM information management section.

10. The HSM control apparatus according to claim 9, wherein
the data migration section stores the file data of a file and path information of the file in
the secondary storage unit.

11. The HSM control apparatus according to claim 9, wherein
the file system is a cluster file system, and
the metadata management section controls the cluster file system.

12. The HSM control apparatus according to claim 9, wherein
the metadata management section controls archive processing that copies the file data from the primary storage unit to secondary storage unit, release processing that releases the file data on the primary storage unit, recall processing that copies the file data from the secondary storage unit to primary storage unit, and invalidation processing that invalidates the file data on the secondary storage unit.

13. The HSM control apparatus according to claim 12, wherein
the metadata management section gives the file, as the file status value, any of the following statuses including: an archive invalidate status where the latest file data exists only in the primary storage unit, an archiving status where the archive processing is being performed, an archived status where the latest file data exists both in the primary and secondary storage units, a releasing status where the release processing is being performed, a released status where the latest file data exists only in the secondary storage unit, an allocating status where the area in the primary storage unit used for the recall processing is being secured, and a recalling status where the recall processing is being performed.

14. The HSM control apparatus according to claim 9, wherein
the HSM information management section selects an archive processing target file based on the HSM information.

15. The HSM control apparatus according to claim 12, wherein
the metadata management section performs collection of tokens from all nodes in the archive processing and release processing.

16. The HSM control apparatus according to claim 9, wherein
the HSM information management section stores a file of several generations in the secondary storage unit through the archive processing and invalidation processing to retain the secondary storage location information of the file so as to manage the file of several generations.

17. An HSM control method that manages a file system using primary and secondary storage units, comprising:
a metadata management step that manages, as metadata of a file, primary storage location information which is location information of file data of the file on the primary storage unit, secondary storage location information which is location information of the file data on the secondary storage unit, and a file status value indicating the status of the file, as well as performs control operation on a file;
an HSM information management step that manages HSM information including a replication of the secondary storage location information and policy information based on the file control performed by the metadata management step; and
a data migration step that migrates the file data between the primary and secondary storage units based on the file control performed by the metadata management step and HSM information managed by the HSM information management step.

18. The HSM control method according to claim 17, wherein the metadata management step controls archive processing that copies the file data from the primary storage unit to secondary storage unit, release processing that releases the file data on the primary storage unit, recall processing that copies the file data from the secondary storage unit to primary storage unit, and invalidation processing that invalidates the file data on the secondary storage unit.

19. The HSM control method according to claim 17, wherein
the metadata management step gives the file, as the file status value, any of the following statuses including: an archive invalidate status where the latest file data exists only in the primary storage unit, an archiving status where the archive processing is being performed, an archived status where the latest file data exists both in the primary and secondary storage units, a releasing status where the release processing is being performed, a released status where the latest file data exists only in the secondary storage unit, an allocating status where the area in the primary storage unit used for the recall processing is being secured, and a recalling status where the recall processing is being performed.

20. The HSM control method according to claim 17, wherein
the HSM information management step stores a file of several generations in the secondary storage unit through the archive processing and invalidation processing to retain the secondary storage location information of the file so as to manage the file of several generations.
